(19) United States
(12) Patent Application Publication
(10) Pub. No.: US 2014/0238783 A1
(43) Pub. Date: Aug. 28, 2014

(54) Guide Rail for Elevator

(71) Applicant: Otis Elevator Company, Farmington, CT (US)

(72) Inventors: James L. Hubbard, Kensington, CT (US); Richard N. Fargo, Plainville, CT (US)

(73) Assignee: Otis Elevator Company, Farmington, CT (US)

(21) Appl. No.: 14/351,349

(22) PCT Filed: Oct. 13, 2011
(86) PCT No.: PCT/US2011/056050

§ 371 Date: Apr. 11, 2014

(51) Int. Cl. B66B 7/02; B21D 47/00

(52) U.S. Cl. CPC B66B 7/02; B21D 47/00
USPC 187/406; 72/46; 427/156

(57) ABSTRACT

A method of making a guide rail for an elevator system method comprising the steps of: providing a guide rail; applying a protective layer to the guide rail for corrosion protection; and removing at least a portion of the protective layer. A sheet metal guide rail for an elevator system comprises a base portion; and a blade portion extending from the base portion. The blade portion includes: a first section for engaging a guiding device and/or a safety of the elevator system; and a second section for engaging a guiding device and/or a safety of the elevator system. The second section contacts the first section. The sheet metal guide rail could be made using the aforementioned method.

### BACKGROUND OF THE INVENTION

This invention generally relates to guide rails. More specifically, this invention relates to guide rails for an elevator system.

Elevator systems typically include a set of guide rails for guiding an elevator car as it moves vertically within a hoistway. Typical guide rails have a generally T-shaped cross-section with a base portion that is secured to a hoistway wall using conventional brackets. A blade portion extending away from the base portion provides guiding surfaces along which guide rollers or slides travel during movement of the elevator car. The blade portion of the guide rail additionally provides a surface that the elevator safeties engage during an overspeed condition. Because of these functions, the blade portion of a guide rail must have suitable surface characteristics. Conventional guide rails are made from steel, and the surfaces must be protected from corrosion during storage and shipment as well as during use in the hoistway. The base portion of a guide rail is typically painted to prevent corrosion. The blade portion, however, is not painted in order to prevent the paint from affecting the operation of the elevator safeties that must act on the blade portion.

Nevertheless, the blade portion of the guide rails should be protected from corrosion during shipment and storage before the time of installation. One conventional method includes applying an anti-corrosion coating, such as wax, to the blade portion. An exemplary wax-base anti-corrosion coating is TECTYL 506 available from The Valvoline Company of Lexington, Kentucky (a division of Ashland, Inc. of Covington, Ky.). The application process may not ensure a consistent application of the coating. In addition, no consistent and/or efficient cleaning process exists to remove the coating and to ensure a suitable surface for the safety to engage. The labor and expense involved with removing the coating introduces additional cost and time required for installation of an elevator system. In addition, the coating must unfortunately be removed at the installation site using a chemical solvent. This technique generates waste, such as rags soaked with solvent, that requires disposal.

### SUMMARY OF THE INVENTION

According to one aspect of the present invention, a method of making a guide rail for an elevator system method comprises the steps of: providing a guide rail; applying a protective layer to the guide rail for corrosion protection; and removing at least a portion of the protective layer.

Alternatively, in this or other aspects of the invention, the guide rail providing step could include the steps of: providing a sheet of metal; and forming the sheet into the guide rail.

Alternatively, in this or other aspects of the invention, the applying step could occur before the forming step.

Alternatively, in this or other aspects of the invention, the forming step could include creating at least one bend in the sheet, and the method could further comprise the step of applying sealant to the bend.

Alternatively, in this or other aspects of the invention, the removing step could comprise peeling at least a portion of the protective layer from the guide rail.

Alternatively, in this or other aspects of the invention, the removing step does not use a solvent.

Alternatively, in this or other aspects of the invention, the applying step could comprise applying a first protective layer and a second protective layer, and the removing step could remove at least a portion of the first protective layer.

Alternatively, in this or other aspects of the invention, the protective layer could be a plastic sheet.

Alternatively, in this or other aspects of the invention, the plastic sheet could include an adhesive backing.

Alternatively, in this or other aspects of the invention, the protective layer could be a coating comprising silicone, acrylic, polyurethane and/or polysulfide.

Alternatively, in this or other aspects of the invention, the method could further comprise the step of cutting the protective layer.

Alternatively, in this or other aspects of the invention, the cutting step could comprise perforating the protective layer.

According to another aspect of the present invention, a sheet metal guide rail for an elevator system comprises a base portion; and a blade portion extending from the base portion. The blade portion includes: a first section for engaging a guiding device and/or a safety of the elevator system; and a second section for engaging a guiding device and/or a safety of the elevator system. The second section contacts the first section.

Alternatively, in this or other aspects of the invention, the guide rail could include a bend between the first section and the second section.

Alternatively, in this or other aspects of the invention, the guide rail could include a first angled section and a second angled section located between the base portion and the blade portion and angled relative to the base portion and the blade portion.

Alternatively, in this or other aspects of the invention, the base portion could further comprise at least one flange.

Alternatively, in this or other aspects of the invention, the flange could comprise: a first flange section; a second flange section; and a bend between the first flange section and the second flange section.

Alternatively, in this or other aspects of the invention, the second flange section could contact the first flange section.

According to another aspect of the present invention, the aforementioned guide rail (or any of its alternatives) could be made according to the aforementioned method (or any of its alternatives).

### BRIEF DESCRIPTION OF THE DRAWINGS

FIG. 1 schematically illustrates selected portions of an elevator system.

FIG. 2 is a perspective view of a conventional T-shaped guide rail.

FIG. 3A is a plan view of a piece of sheet metal prior to being formed into an elevator guide rail with one possible arrangement of a protective layer of the present invention.

FIG. 3B is a plan view of a piece of sheet metal prior to being formed into an elevator guide rail with another possible arrangement of a protective layer of the present invention.

FIG. 3C is a plan view of a piece of sheet metal prior to being formed into an elevator guide rail with another possible arrangement of protective layer of the present invention.

FIG. 4A is a plan view of the sheet metal of FIG. 3A formed into one possible arrangement of a guide rail of the present invention.

FIG. 4B is a plan view of the guide rail of FIG. 4A with a section of the protective layer subsequently removed.

FIG. 5A is a plan view of the sheet metal of FIG. 3B or FIG. 3C formed into one possible arrangement of a guide rail of the present invention.

FIG. 5B is a plan view of the guide rail of FIG. 5A with a section of the protective layer subsequently removed.

FIG. 6A is a plan view of a conventional guide rail with one possible arrangement of a protective layer of the present invention.

FIG. 6B is a plan view of the guide rail of FIG. 6A with a section of the protective layer subsequently removed.

### DETAILED DESCRIPTION OF THE INVENTION

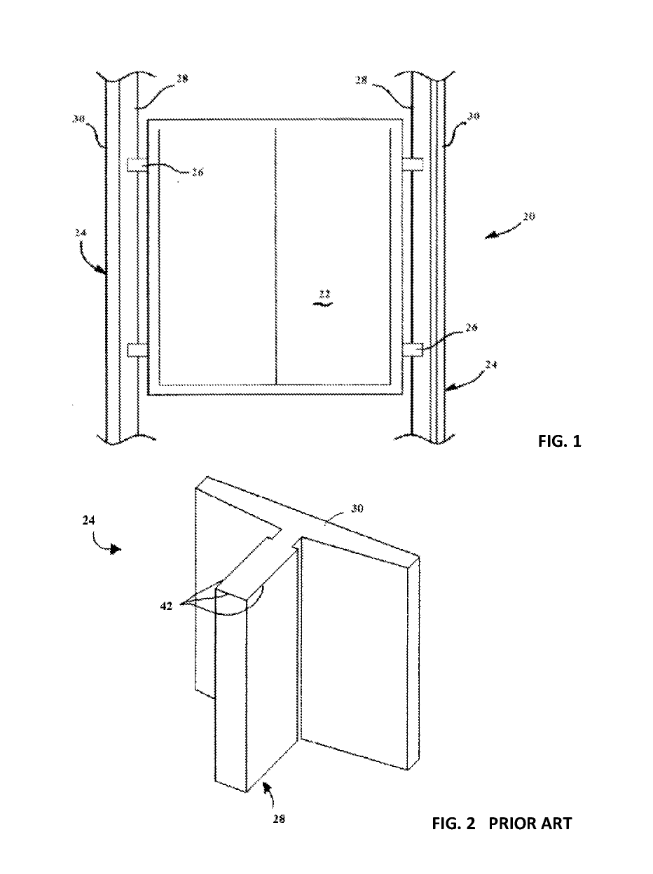

FIG. 1 schematically shows selected portions of an elevator system 20. Components of the elevator system that are not relevant to the present invention (e.g. ropes/belts, governor assembly, etc.) are not discussed. An elevator car 22 can travel along one or more guide rails 24 through the operation of one or more guiding devices 26 mounted to the car 22. Examples of said guiding devices 26 include roller guides or sliding guide shoes that engage the guide rails 24 in a known manner.

In some arrangements, although not shown in the figures, the elevator system could include a counterweight that can also travel along one or more guide rails through the operation of one or more guiding devices. The counterweight guide rails could also benefit from the present invention.

FIG. 2 provides a conventional guide rail. The guide rail 24 includes a blade portion 28 and a base portion 30. The base portion 30 facilitates mounting the guide rail 24 within a hoistway, for example using known brackets. The blade portion 28 extends from the base portion 30 and engages the guiding devices 26 during movement of the elevator car 22. In this illustrated example, the blade portion 28 has multiple guiding surfaces 42 along which the guiding devices 26 travel. At least one of the guiding surfaces 42 also serves as a braking surface for elevator safeties (not shown) to engage. As is known, elevator safeties engage the guide rail 24 during certain events, such as an over speed condition.

The engagement of a safety on the guide rail 24 creates a significant bending moment on the guide rail 24. Guide rails 24 are conventionally made from cold-rolled steel to achieve the stiffness necessary to withstand such bending moment.

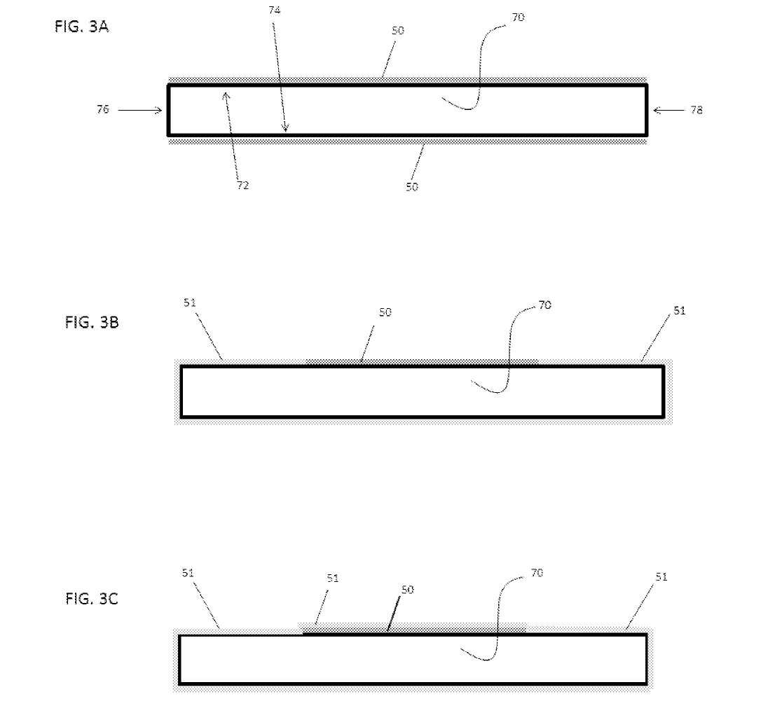

The present invention could be used on conventional guide rails 24 or guide rails 24 made from sheet metal. FIGS. 3A, 3B and 3C display a flat piece of sheet metal 70 prior to being formed or bent into guide rail 24. One or more surfaces of the sheet metal 70 could be covered with a protective layer.

The sheet metal 70 of FIG. 3A includes a top surface 72, bottom surface 74, left side surface 76 and/or right side surface 78. Some or all of the surfaces 72, 74, 76, 78 could receive a protective layer 50. As an example, all four surfaces 72, 74, 76, 78 of the sheet metal 70 could receive the protective layer 50. As another example, only the surface(s) that will be engaged by the safety could receive the protective layer 50 (e.g. top surface 72). As yet another example, only the surface(s) that will not be engaged by the safety could receive the protective layer 50 (e.g. bottom surface 74, left side surface 76 and/or right side surface 78). As yet another example, and as specifically shown in FIG. 3A, just the major surfaces of the sheet metal 70 could receive the protective layer 50 (e.g. top surface 72 and bottom surface 74) and not the minor surfaces (e.g. left side surface 76 and right side surface 78).

The protective layer 50 may be applied to the desired surface(s) of the guide rail 24 at any suitable step in the process. In an exemplary guide rail 24 formed of sheet metal 70, the protective layer 50 may be applied at any suitable step between (and including) the initial forming of the sheet metal 70 (e.g. the sheet metal manufacturer performs the application) and the use of the guide rail 24 by an elevator system in a hoistway (e.g. the installer of the guide rails 24 performs the application). As a specific example, the protective layer 50 could be applied to the sheet metal 70 before forming/bending the sheet metal 70 into a guide rail 24. The application of the protective layer 50 to the sheet metal 70 could be a manual process, automated process or a semi-automated process.

As an example, the protective layer 50 could be made of one or more plastic materials (in one or more layers), such as polyethylene, formed into a sheet. The protective layer 50 may include corrosion inhibitors such as hexamine, benzotriazolel, phenylenediamine, dimethylethanolamine, polyaniline, nitrate, or nitrite.

The sheet could also have an adhesive backing. As an example, the adhesive backing suitably retains the protective layer 50 to the guide rail 24 (e.g. during transport, installation and use) but allows for removal of the protective layer 50 (or portions thereof) including the adhesive backing when desired. In this arrangement, the protective layer becomes a removable layer 50. An exemplary product to be used as removable layer 50 is 30L60 Medium Tack Protection Film available from Presto Tape, Inc. of Bensalem, Pennsylvania.

Rather than the aforementioned sheet, the protective layer 50 could be a protective coating 50 applied to the guide rail 24 (or, with sheet metal guide rails, the sheet metal 70). Such coatings could be, for example, a liquid coating applied by a suitable method such as spraying, dipping, brushing and/or pouring and allowed to cure or dry. Exemplary protective coatings 50 include silicone, acrylic, polyurethane, or polysulfide.

Although various exemplary materials have been provided, those skilled in the art and those with the benefit of this description will be able to select appropriate material(s) for the protective layer 50 to meet the needs of a particular situation.

FIGS. 3B and 3C provide two alternative arrangements of the protective layer. Other embodiments are also possible. In FIG. 3B, the protective layer 50 covers a desired portion of the sheet metal 70 and a second protective layer 51 covers a different portion of the sheet metal 70. As an example, the protective layers 50, 51 could, combined, cover all or just a portion of the sheet metal 70. The protective layer 51 could be different than the protective layer 50, for example using the conventional materials mentioned above like paint or wax base anti-corrosion materials, or having a stronger adhesive backing (so the protective layer 51 is not a readily removable/peelable).

In FIG. 3C, the second protective layer 51 covers the protective layer 50. In essence, the protective layer 50 acts as a mask during the application of the protective layer 51. As discussed with the prior alternative arrangement, protective layers 50, 51 combined could cover all, or just a portion, of the sheet metal 70. The protective layer 51 could be different than the protective layer 50, for example using the conventional materials mentioned above like paint or wax base anticorrosion materials.

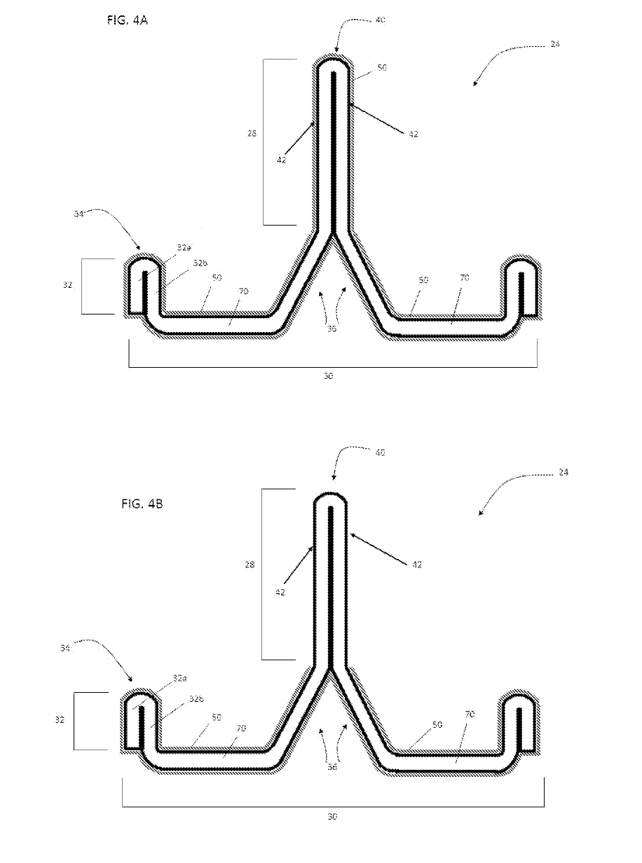

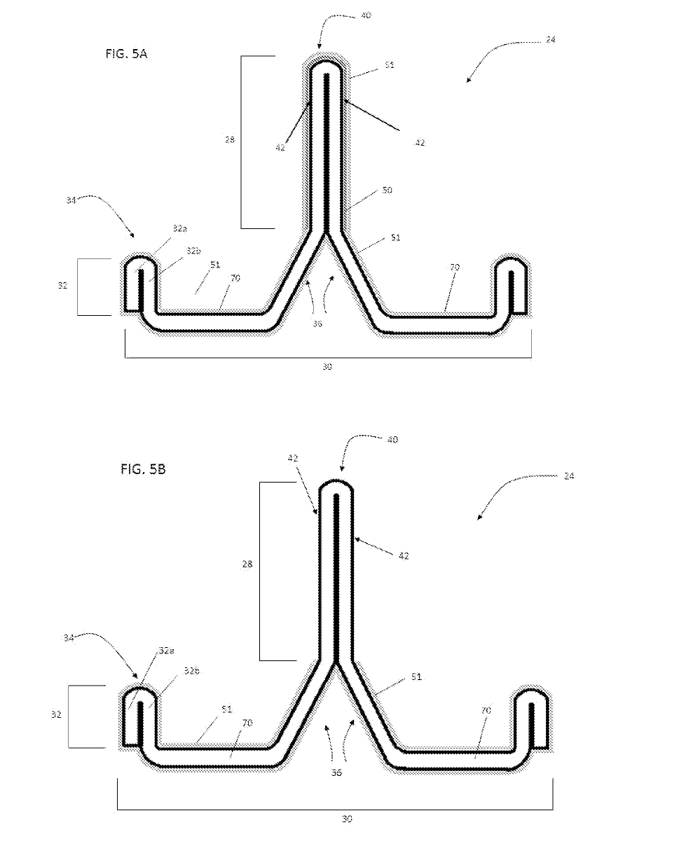

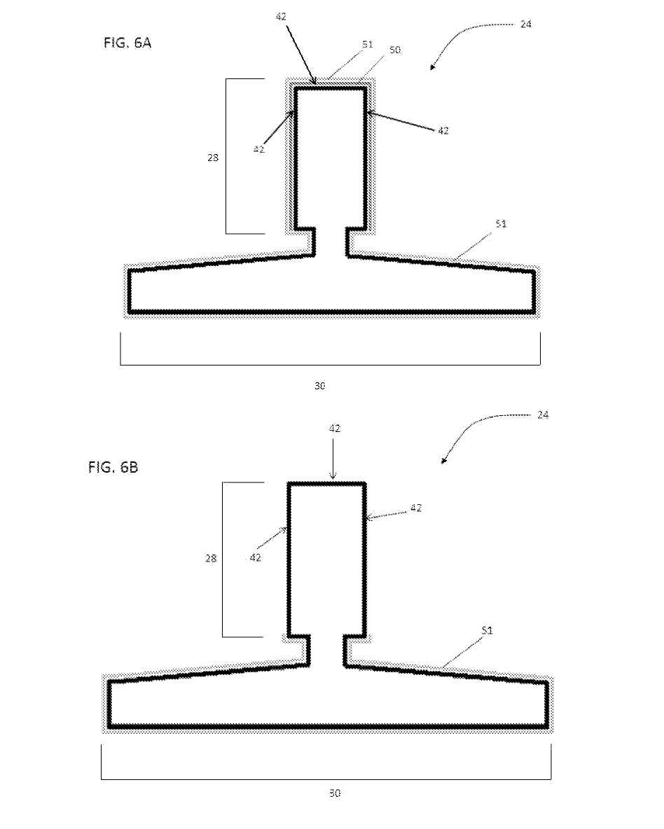

FIGS. 4A-5B provide an exemplary guide rail 24 of the present invention that could be made from the sheet metal 70 provided in FIGS. 3A-3C. The guide rail 24 shown in FIGS. 4A-5B is generally Y-shaped, with blade portion 28 and base portion 30. Each end of the base portion 30 can include a flange 32 for example to provide additional stiffness to the rail. The flange 32 can extend at an angle, such as about 90°, from the base portion 30. The flange 32 can be formed by a bend 34, such as about a 180° bend, in the sheet metal 70. In this arrangement, the bend 34 can produce two flange sections 32a, 32b that can be generally parallel (and generally contacting).

The base portion 30 can include two angled sections 36 that transition from the base portion 30 to the blade portion 28. The angled sections 36 extend at an angle, such as about 60°, from the base portion 30. The angled sections 36 can provide additional stiffness to the guide rail 24.

The blade portion 28 can include a bend 40, such as about a 180° bend, in the sheet metal 70. The bend 40 can produce has two generally parallel (and generally contacting) sections 42 of the sheet metal 70. The bend 40, as seen in the figures, can be at the nose (or tip) of the guide rail 24. One or both of the sections 42 are engaged by the elevator safety (these sections may also be engaged by the guiding device 26). The bend 40 provides additional stiffness to the guide rail 24 to withstand the braking forces caused by the elevator safety. The sections 42 of the sheet metal 70 also provide additional stiffness to the guide rail 24 since these sections 42 contact each other for a length of the blade portion 28 (e.g. between bend 40 and angled sections 36), in essence creating blade portion 28 that is twice as thick as base portion 30.

The use of the protective layer(s) on the guide rail 24 shown in FIGS. 4A-5B can help maintain the desired thickness of the blade portion 28 by preventing corrosion. Corrosion, including crevice corrosion (e.g. the crevices formed by the bends 34, 40), could alter (usually increase) the thickness of the blade portion 28 and impact system performance. Thus, as an example, the protective layer 50 (FIGS. 4A/4B) or the protective layers 50, 51 (FIGS. 5A/5B) could be applied to those sections of the sheet metal 70 where crevice corrosion could occur, such as sections of the bottom surface 74 of sheet metal 70 at the bends 34, 40 and the areas adjacent these bends (i.e. the length where the sheet metal 70 contacts itself) such as in the flanges 32 and blade portion 28. Other sections and other surfaces could also receive the protective layer.

Alternatively or in addition to the protective layer(s), a sealant (not shown) could be used to protect against crevice corrosion. Exemplary sealants include silicone, acrylic, polyurethane, or polysulfide.

Despite its benefits, proper operation of the elevator safety demands that some of the area on one or both of the sections 42 that are engaged by the elevator safety must not have any protective layer. One possible way to ensure the area of one or both of the sections 42 do not have any protective layer is to never adding a protective layer to those areas.

An alternative manner of ensuring the area of one or both of the sections 42 do not have the protective layer during use of the elevator system is to remove the protective layer from those areas before using the elevator safeties. As an example, the protective layer 50 could be cut/perforated before being applied to the sheet metal 70 (i.e. pre-cut/pre-perforated) or after being applied to the sheet metal 70. The cut/perforation (not shown) makes at least one section of the protective layer 50 removable at any suitable step in the process. For example, a section of the protective layer 50 (and the protective layer 51 if overlaying the protective layer 50 as in FIG. 3C) could be removed after installation of the guide rail 24 in the hoistway (i.e. protecting this section of the guide rail 24 during shipment and installation), with the rest of the protective layer(s) 50, 51 remaining on the guide rail 24 even after installation of the guide rail 24 (i.e. additionally protecting this section of the guide rail 24 during use). As an example, the elevator mechanic/installer could remove the desired section of the protective layer 50 (and the protective layer 51 if overlayed as in FIG. 3C) once the rail is installed in the elevator hoistway by manually peeling off the protective layer 50. The adhesive should remain with the removable layer 50 as it is peeled from the rail, leaving little or no residue on the surface of the guide rail 24. FIGS. 4B and 5B shows the sheet metal guide rail 24 after the mechanic/installer has removed the desired section(s) of the removable layer 50 (and the protective layer 51 if overlayed as in FIG. 3C). As particularly shown in the figures the mechanic/installer has removed the removable layer 50 from the sections 42 (FIG. 4B), and the removable layer 50 and protective layer 51 from the sections 42 (FIG. 5B).

FIGS. 6A and 6B display the use of the protective layer of the present invention on a conventional guide rail 24. In FIG. 6A, the protective layer 50 covers a desired portion of the guide rail 24, such as the sections 42. The guide rail 24 could include a second protective layer 51. The protective layer 51 could (as shown in FIG. 6A) be applied over protective layer 50 and/or the protective layer 51 could cover a different portion of the guide rail 24 than protective layer 50. As an example, the protective layers 50, 51 could, combined, cover all or just a portion of the guide rail 24. The protective layer 51 could be different than the protective layer 50, for example using the conventional materials like the aforementioned paint or wax base anti-corrosion materials, or having a stronger adhesive backing (so the protective layer 51 is not a readily removable/peelable).

With the disclosed method, the process of removing a form of corrosion protection can be simplified, more reliable, and/or in some cases more economical. The preceding description is exemplary rather than limiting in nature. Variations and modifications to the disclosed exampled may become apparent to those skilled in the art that do not necessarily depart from the essence of this invention. The scope of legal protection given to this invention can only be determined by studying the following claims.

1. A method of making a guide rail for an elevator system, comprising the steps of:
providing a sheet metal guide rail;
applying a protective layer to the guide rail for corrosion protection; and
removing at least a portion of the protective layer.

2. The method of claim 1, wherein the guide rail providing step includes the steps of:
providing a sheet of metal; and
forming the sheet into the guide rail.

3. The method of claim 2, wherein the applying step occurs before the forming step.

4. The method of claim 2, wherein the forming step includes creating at least one bend in the sheet, and further comprising the step of applying sealant to the bend.

5. The method of claim 1, wherein the removing step comprises peeling at least a portion of the protective layer from the guide rail.

6. The method of claim 1, wherein the removing step does not use a solvent.

7. The method of claim 1, wherein the applying step comprises applying a first protective layer and a second protective layer, and the removing step removes at least a portion of the first protective layer.

8. The method of claim 1, wherein the protective layer is a plastic sheet.

9. The method of claim 8, wherein the plastic sheet includes an adhesive backing.

10. The method of claim 1, wherein the protective layer is a coating comprising silicone, acrylic, polyurethane and/or polysulfide.

11. The method of claim 1, further comprising the step of cutting the protective layer.

12. The method of claim 111, wherein the cutting step comprises perforating the protective layer.

13. (canceled)

14. A sheet metal guide rail for an elevator system, comprising:
a base portion; and
a blade portion extending from the base portion, the blade portion including:
a first section for engaging a guiding device and/or a safety of the elevator system; and
a second section for engaging a guiding device and/or a safety of the elevator system, the second section contacting the first section.

15. The guide rail of claim 14, further comprising a bend between the first section and the second section.

16. The guide rail of claim 14, further comprising a first angled section and a second angled section located between the base portion and the blade portion and angled relative to the base portion and the blade portion.

17. The guide rail of claim 14, wherein the base portion further comprises at least one flange.

18. The guide rail of claim 17, wherein the flange comprises:
a first flange section;
a second flange section; and
a bend between the first flange section and the second flange section.

19. The guide rail of claim 18, wherein the second flange section contacts the first flange section.

20. The guide rail of claim 14, wherein at least a portion of the guide rail has a removable protective layer thereon for corrosion protection.
